(19) United States
(12) Patent Application Publication
(10) Pub. No.: US 2003/0092522 A1
(43) Pub. Date: May 15, 2003

(54) Latched snap-in connection

(75) Inventors: Christian Sauter, Embrach (CH); Paul Cahannes, Embrach (CH); Peter Weber, Graslikon (CH)

Correspondence Address: STEPHEN E. BONDURA, ESQ., DORITY & MANNING, P.A., P.O. BOX 1449, GREENVILLE, SC, 29602-1449, US

(73) Assignee: MASCHINENFABRIK RIETER AG

(21) Appl. No.: 10/176,108

(22) Filed: Jun. 20, 2002

(30) Foreign Application Priority Data
Jun. 21, 2001 (CH) 1130/01
Mar. 5, 2002 (DE) 102 09 579.5

(51) Int. Cl. F16G 1/28; F16G 5/20

(52) U.S. Cl. 474/202

(57) ABSTRACT

EP-A-627505 describes a connecting system between a revolving flat bar of a revolving flat card and a flexible drive belt. The system is based on snap-in connections. According to EP-A-753610, every snap-in connection comprises two rails (230) which each touch an inclined surface (214, 216) on the belt. According to the present invention such a snap-in connection can be supplemented by a locking element (300) which prevents an inadvertent loosening of the snap-in connection.

The invention relates to the connection between a flat bar and a flexible drive belt in the flat arrangement of a revolving flat card. Such a connection is shown in EP-A-627507 and in EP-A-753610 (or U.S. Pat. No. 5,956,811).

The belt according to EP-A-627507 comprises fastening elements provided in pairs which form with the flat bar a snap-in connection. EP-A-753610 shows a special drive belt for the flat bars of a revolving flat card, with the belt being provided with connecting elements which are formed integrally with a flexible belt and are arranged in pairs, so that one pair of elements in a flat bar part can be received for forming a snap-in connection. Each element comprises a transversal beam with an inclined surface, with the inclined surfaces of a pair of beams being directed in mutually opposite longitudinal directions of the flexible belt.

It was the object of the solution according to EP-A-753610 to propose embodiments with which mutually contradictory requirements could be fulfilled, namely that on the one hand the flat bar remains rigidly connected in a predetermined position with the drive belt during the operation of the flat bar arrangement, but that on the other hand the flat bar can be easily removable and re-attachable if required (e.g. during maintenance).

Although not mentioned expressly in the specifications, it was also an object of the mentioned inventions to allow a connection which does not require any additional fastening elements. It was noticed, however, that the latter goal was set too high with respect to the high demands made by spinning and threatened the fulfillment of the aforementioned target requirements.

It is an object of the present invention to increase the operational reliability of a revolving flat arrangement with a snap-in connection between a drive belt and a flat bar as compared with the aforementioned state of the art. Solutions to achieve this object are obtained from the combination according to the following claims.

The solution in accordance with the invention is suitable not only in the known flat bars with cuboid flat heads, but also in flat bars which are provided with bar-like slide pins, e.g. according to EP-A-567747.

Further advantages follow from the description below. The invention is explained there in closer detail on the basis of examples shown in the drawings. The explanation starts out from the embodiments according to EP-A-627507 and EP-A-753610, so that said latter solutions are explained first (as the “initial situation”).

### THE DRAWINGS SHOW THE FOLLOWING

FIG. 1 shows a schematic view of a revolving flat card;

FIG. 2 shows a schematic representation of a part of the revolving flat arrangement of a carding machine according to FIG. 1;

FIG. 3 shows a perspective view of the preferred embodiment according to EP-A-627507;

FIG. 4 shows a perspective representation of a drive belt according to EP-A-753610;

FIG. 5 shows a view of the belt according to FIG. 4;

FIG. 6 shows a view of the face side of a flat bar with an end-head portion which is arranged for cooperation with the elements according to FIG. 5 and is shown in a cross-sectional view;

FIG. 7 shows the end-head portion according to FIG. 6 in a plan view;

FIG. 8 shows a longitudinal sectional view through a belt according to FIG. 5 with an end head carried according to FIG. 7 which is carried jointly by the same;

FIG. 9 shows a view of the belt according to FIG. 5 with such a curvature that the holding forces of the connecting elements are increased;

FIG. 10 shows a view of the part according to FIG. 7 when being brought together with a belt according to FIG. 5;

FIG. 11 shows a view of the belt according to FIG. 5 with such a curvature that the distance between the connecting elements is thus decreased;

FIG. 12 shows a view of the guide means for a drive belt of the revolving flat unit in order to explain the production of the curvature according to FIG. 11;

FIG. 13 shows a view of a modification of the arrangement according to FIG. 12;

FIG. 14 shows a flat bar which is carried between two belts of the kind as shown in FIG. 4;

FIG. 15 shows a plan view of an alternative to the belt body as shown in FIG. 5;

FIG. 16 shows another alternative of the belt body with an inclined surface which produces the holding of the flat bar;

FIG. 17 shows a belt body which works according to the holding principle which was described in connection with FIG. 9, but without the inclined holding surface;

FIG. 18 shows a diagram similar to FIG. 9 which shows a pair of beams represented in FIG. 17;

FIG. 19 shows a schematic representation of the path a flat in a set of flats;

FIG. 20 shows a copy of FIG. 8 with a modification according to the present invention;

FIG. 21 schematically shows an alternative embodiment of the variant according to FIG. 20;

FIG. 22 shows a further copy of FIG. 8 with a second modification according to the present invention;

FIG. 23 shows a copy of FIG. 8 with a modification according to the embodiment shown in FIG. 22;

FIG. 24 shows a schematic representation of a variant of the embodiment according to FIG. 22;

FIG. 25 shows a modification of the variant according to FIG. 24;

FIG. 26 shows a view of a further embodiment of the invention according to the present invention;

FIG. 27 shows the embodiment according to FIG. 26 as viewed in the direction of arrow Po;

FIG. 28 shows the embodiment according to FIG. 26 as viewed in the direction of arrow Pu;

FIG. 29 shows a cross-sectional view of a belt portion with connecting elements which can cooperate with the embodiment according to FIG. 26;

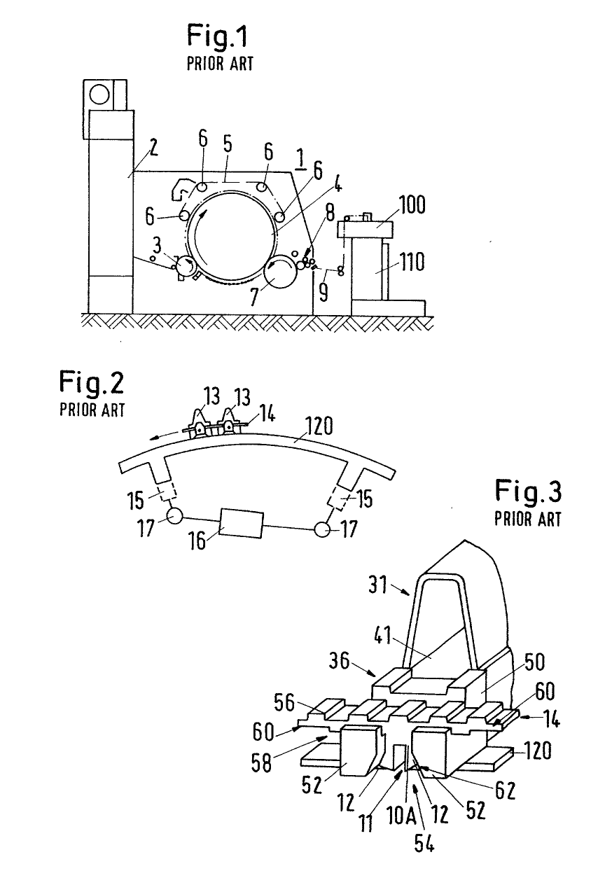

FIG. 1 shows a known revolving flat card 1, e.g. the carding machine C51 of the applicant, in a schematic view. The fiber material is supplied in the form of opened and cleaned flocks to the fiber tuft feeder 2, received by a licker-in 3 (also known as taker-in) as lap feed, transferred to a main cylinder 4 and parallelized by the flat of a revolving flat unit 5. The flats are driven via deflection rollers 6 in synchronicity or in the opposite direction to the direction of rotation of the main cylinder 4. Fibers from the non-woven material situated on the main cylinder 4 are taken up by the doffer 7 and formed into a card sliver 9 by an outlet section 8 consisting of various rollers. Said card sliver 9 is deposited by a can coiler 100 in transport can 110 in cycloidal windings.

FIG. 2 shows in a sectional view the flexible bend 120 of such a carding machine, with revolving flats 13 revolving thereon (of which only two are shown) which are moved slowly by a toothed belt 14 and a drive (not shown) in synchronicity or in the opposite direction to the direction of rotation of the main cylinder 4. Adjusting members 15 are provided on said flexible bend 120 with which the distance of the revolving flat 13 to the cylinder surface (i.e. the so-called carding distance) can be set. The revolving flat unit of a carding machine according to DE-A-3835776 for example, comprises 106 flat bars, of which 41 are in the working position, i.e. they are in contact with the slideway.

FIG. 3 shows the preferred embodiment according to EP-A-627507 for connecting flat bars with a (toothed) drive belt. A head element 36 of a flat bar 31 comprises a slide-in part 41 and a sliding section 50. The part 41 extends into the receiving section of a hollow profile and is fixed therein, e.g. according to EP-A-627507.

The sliding section 50 is guided in the working position of the flat bar along the flexible bend 120 and, during the return run, along a rail (not shown). The sliding section 50 is provided with two projections 52 and the two projections 52 jointly form a receiving opening 54.

The drive belt 14 is arranged as a toothed belt. The teeth on the “inner surface” 56 of the belt (i.e. on surface 56 which with respect to the revolving closed path faces inwardly) cooperate with drive wheels (not shown). On the “outside surface” 58 of the belt which in the working position of the flat bars is positioned opposite of the flexible bend 120 there are recesses 60 arranged in pairs, with the recesses 60 receiving a projection 52 each. Between the recesses 60 of each pair the belt 14 is provided with a projection 10A which is formed integrally with the belt. The projection 10A is received in the receiving opening 54 between the projections 52. The projection is provided with a slot 11, as a result of which two “legs” are formed, whereof each is provided in the base region with a cam 12. The projections 52 are each provided with an inclined surface 62 in order to better receive and hold the cams 12. The legs are elastic and can be compressed in order to form a snap-in connection with the head part 36 of the flat bar 31.

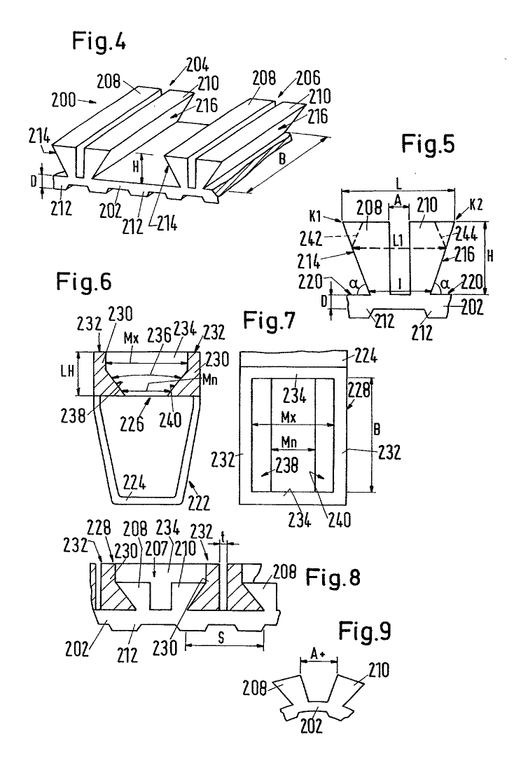

FIG. 4 shows an embodiment of a belt according to EP-A-753610, with only a short section of an oblong structure being shown in the figure. The belt is indicated in its entirety with reference numeral 200. It comprises a body 202 which continues in the longitudinal direction, pairs 204 or 206 of connecting elements 208 or 210 as well as teeth 212. The belt is cast in one piece. Reinforcements (e.g. filaments or wires, which are not shown) which extend in the longitudinal direction can also be cast into the belt. The (matrix) material is preferably an elastomeric material such as polyurethane.

The body 202 is provided with a predetermined width B (e.g. in the range of 20 to 30 mm) and a predetermined thickness D (e.g. in the range of 1 to 3 mm). The thickness D can be chosen depending on the tensile forces to be transmitted, e.g. depending on the number of flat bars.

Every connecting element 208 or 210 consists of a cross-beam which extends over the entire width B of the body 202, namely perpendicular to the longitudinal direction of the body. Every beam 208 and 210 is provided with a predetermined height H (e.g. in the range of 3 to 8 mm). The beam 208 and 210 is wedge-shaped in the cross section, with the smaller “root” of the wedge 202 being adjacent to the body 202 and the larger head portion being remote from the body 202. The beams 208, 210 of a pair (e.g. of pair 204, which is also shown in FIG. 5) are disposed in a mirrored fashion opposite of each other and there is a distance A (referred to hereinafter as “nominal distance”) between the two beams of the pair, which distance is the same over the entire height of the beams when the body 202 is currently stretched (FIG. 5). In the illustrated example, the “slot” forming the distance extends downwardly up to the root of the beams.

Every beam therefore comprises an inclined surface 214 or 216 and the inclined surfaces of a pair face in opposite longitudinal directions. In the illustrated example every inclined surface of a pair (e.g. pair 204, FIG. 4) is situated opposite of an inclined surface of the adjacent pair (e.g. of pair 206). The inclined surface 214 or 216 of a beam encloses with the adjacent surface 220 of body 202 a predetermined angle α (e.g. in the range of 60 to 80 degrees) when the body 202 is in the stretched position. As will be explained below in closer detail, every beam 208 or 210 is rubber-elastic at least in the root zone, so that the beams can be pushed by means of suitable forces towards the inclined surfaces (or in the head zone generally) against each other in order to reduce their mutual distance in the head zone.

A belt body according to FIG. 4 or 5 is cut (or formed) for use to a predetermined overall length and the end parts of the body are then connected with each other in order to enable an endless belt for use in a revolving flat unit 5, 6 according to FIG. 1. This thus defines a “revolving flat path” for the flat bars which are connected with the belt during operation. Opposite of said revolving flat path there are the teeth 212 on the inner side of the endless belt and the pairs of beams 204, 206 stand on the outside surface 220.

It is assumed at first that the endless belt 200 moves in the own longitudinal direction, so that each pair of beams 204, 206 is moved from the right to the left in FIGS. 4 and 5. Preferably, each pair of beams is arranged symmetrically, so that it actually does not play any role in which direction it is moved. The assumption of a certain direction simplifies the following description. In the “readiness state” (body 202 is stretched in a straight fashion, without any force being exerted on the beam 208, 210) the distance in the longitudinal direction of the body 202 between the preceding free edge K1 of the beam pair 204 (FIG. 4) and the trailing free edge K2 of the same pair has a predetermined value “L” which can lie in the range of 12 to 25 mm. The distance “L” is referred to hereinafter as “span” of the beam pair. The respective distance “l” at the root of the beam 208, 210 is in the same state a smaller predetermined value which can lie in the range of 9 to 22 mm.

A flat bar which is to cooperate with this belt is indicated with the reference numeral 222 in FIG. 6 and comprises a hollow profile 224 and two end heads 226, of which only one is shown in FIG. 6 or 7. Every end head 226 comprises a connecting part (not visible in these figures; see insert part 41 in FIG. 3) which is pressed into the respective end part of profile 224 and is fixed therein. The preferred solution for fastening the end heads 226 in the profile 224 has been described in EP-A-627527. At each end of the profile a sliding block/clamp part 228 (FIG. 7) of the respective end head 226 projects out of the end of the profile. The part 228 comprises two rails 230 (FIG. 6) which extend in the longitudinal direction of the bar 222. These rails 230 each form a sliding surface 232 which slides along the sliding surface of the flexible bend when the bar 222 is in the working position. The rails 230 are formed integrally with cross-beams 234 which together with the rails form a receiving means of predetermined dimension for the respective elements of the belt 200. The size of this opening in the longitudinal direction of the rails 230 preferably corresponds to the belt width (or the beam length) B (see FIG. 7 and FIG. 4). It is thus ensured that the belts of the revolving flat unit and the flat bars of the unit mutually center each other laterally.

The clamping and connecting function is fulfilled by two rail parts 236 (FIG. 6) which are also wedge-shaped in their cross section, so that they are each provided with an inclined surface 238 and 240, respectively. Said inclined surfaces 238, 240 are disposed so as to face each other and they are provided with a predetermined minimum distance Mn (FIG. 7) which is considerably smaller than the span L (FIG. 5) of a pair of beams in the aforementioned state of readiness. The inclined surfaces are provided with a predetermined maximum distance Mx (FIG. 7) which shall be explained below. The distances Mn and Mx are designated below as the “opening widths” of the clamping part.

FIG. 8 shows a sliding block/clamp part 228 in connection with a pair of beams 207 of the belt 200. The clamp part has been snapped over the pair of beams, so that the inclined surfaces 238, 240 are in connection with the inclined surfaces 214, 216 of the beams. The height of each wedge-shaped part of the rails 230 is approximately equivalent to the height H of the beams 208, 210. The total height LH (FIG. 6) of each rail 230 is considerably larger, so that the sliding surfaces 232 (in the arrangement according to FIG. 8) lie far above the beams 208, 210.

Every flat bar 222 is connected in the same manner with a pair of beams each. The distance between adjacent flat bars 222 is predetermined and should be kept as small as possible. It is designated in FIG. 8 with the reference numeral “t”. The distance t is naturally given by the construction of the rails 230 and the distance between adjacent pairs of beams. The latter distance is also predetermined and is at the roots of the beams 208, 210 (on the surface 220 of body 202) the value “S” (FIG. 8) which is in the range of 14 to 27 mm.

Every snap-in connection according to FIG. 8 was designed to produce holding forces in such a way that the following minimum requirements are fulfilled:

the sliding surfaces 232 (FIG. 7) sit in close fit and in a stable fashion on the sliding surfaces of the flexible bends (resistance against moments of tilt);

the drive forces are reliably transmitted by belt 200 onto the flat bar 222 in the operating position and during the return run;

the flat bars 222 are held securely by the belt 200 at the deflection points.

The measures made according to EP-A-753610 shall be repeated here again, with additional measures being taken according to the present invention in order to ensure that the requirements are always fulfilled in spinning operation. Said additional measures are explained below by reference to the FIGS. 20 through 25.

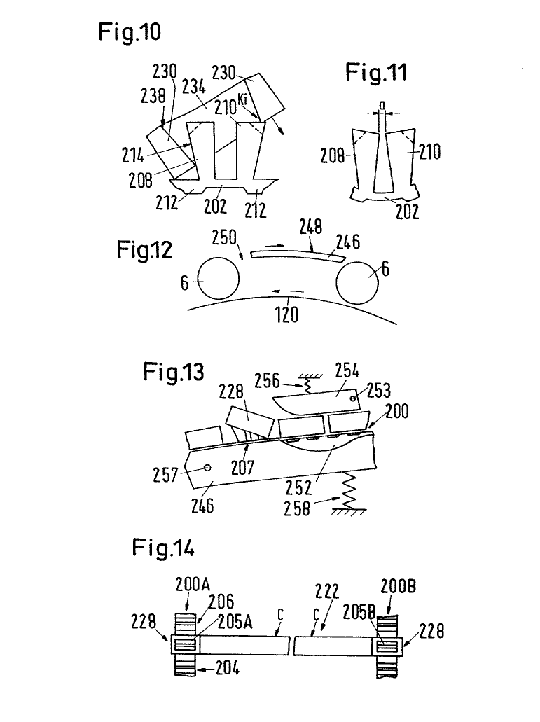

The width Mn of the input opening of the clamp is preferably approximately as large as the dimension “l” (FIG. 5) at the root of the beams 208, 210. The maximum width Mx of the clamp is preferably not as large as the span L of the pair of beams. In the mounted state (FIG. 8) the distance of the beams in the head zone is slightly reduced with respect to the nominal distance A, which means that the rails 230 also push the beams 208, 210 against each other in the fully latched state. The beams 208, 210 are pushed together even more during the oversnapping of the clamp as will be explained below with reference to FIGS. 10 through 12.

The holding forces are also influenced by the “degree of bending” of the belt body, as will be explained first on the basis of FIG. 9. The FIGS. 4, 5 and 8 all show (for reasons of simplicity) the belt body 200 in the stretched state. The revolving flat path is not straight at any place and it comprises in the end zones two partial sections at the deflection rollers which require a considerable bending of the belt body. The outside surface of the body 202 with the beams 208, 210 is transformed in a convex manner. The effect of said bending in the absence of a clamp is shown in FIG. 9. The beams 208, 210 of each pair are pulled apart especially in the head zone, so that the distance between the beams increases from the nominal distance A (FIG. 5) to A+ (FIG. 9). Such an increase is not possible in the presence of a clamp, because the rails 230 are strong enough to withstand the “elastic forces” of the pair of beams. Said elastic forces produce a considerable increase of the holding forces while a pair of beams carrying a flat bar moves about a deflection roller 6 (FIG. 1).

The snap-in connection must also allow the release of a flat bar (e.g. during the maintenance of the flat bars or for checking a flat bar) and the (re-)attachment of a bar, which should be possible during the (still) running revolving flat unit. The attachment of a bar is shown schematically in FIG. 10. One of the inclined surfaces of the clamp (in the illustrated example it is the surface 238) is brought into contact at first with the inclined surface (214 in FIG. 10) of the respective beam (208 in FIG. 10). The flat bar 222 is inclined in such a way that the edge K1 at the other rail of the clamp can be brought into contact with the head of the other beam 210 (state according to FIG. 10). When pressure is applied on the still free-standing rail, the beam 210 is elastically deformed in such a way that the edge K1 can move past the edge K2 (FIG. 5), which means the latching of the clamp.

The simple beam head shape according to FIGS. 4, 8 and 10 comprises a face surface which is situated in a single plane. If this shape is chosen, one must expect problems both during the “pressing in” as well as with damage to edges K1 and K2. A partial solution to this problem has been indicated with the broken lines in FIG. 5, where the face surface has been inclined in order to form guide surfaces 242, 244. As compared with the variant with the unbroken lines, the span of the pair of beams decreases to L1. The transition between a guide surface and the respective inclined surface of the beam is preferably more rounded off than edge-shaped. This constructional exception simplifies the pressing in accordance to FIG. 10. The attachment as well as the detachment of a flat bar may under certain circumstances still be somewhat cumbersome for an operator. This problem can be solved elegantly by reversing the effect according to FIG. 9. The solution is schematically shown in FIG. 11.

A bending of the belt body 202 with the beams 208, 210 on the concave surface of the belt brings the head zones of the beams together; the beam distance is reduced with respect to the nominal distance A (FIG. 5) to “a” (FIG. 11) or even cancelled. The span L or L1 is reduced accordingly, which helps ease the pressing in. A minimum bending of this kind can be produced when a flat bar 222 is placed on the sliding surface of the flexible bend 120 (FIG. 12). The respective loosening of the holding forces occurs at a location, however, which is unsuitable for the attachment or removal. The latter function should be carried out on the return path 246. In this case the belt 202 is preferably supported by a return rail 248 which may even be provided with a slight curvature in the “wrong” direction. At at least one position (e.g. 250, FIG. 12) no guidance should be provided for the belt, so that the operator can produce the desired bending of the belt (with or without tools) himself or herself. This “mounting location” is preferably situated in the zone where a belt part during its movement leaves the revolving flat path along a deflection roller and the return rail has not yet been reached. The mounting location can also be positioned at another place on the return path or it is even possible to distribute a number of mounting locations along the path. The important aspect is that the mounting locations for the two belts of a revolving flat unit correspond to each other.

FIG. 13 shows a modification of the arrangement according to FIG. 12 where the return rail 246 is provided with a recess 252 and said recess 252 is associated with a securing plate 254. When a pair of beams (e.g. 207) approaches plate 254 with an incorrectly mounted flat bar with the sliding head 228, the plate 254 presses the clamp part of the sliding head 228 downwardly over the pair of beams. For this purpose the plate 254 is carried rotatably about a shaft 253 and pretensioned by an elastic means (e.g. spring 256) in the direction of recess 252. The plate usually maintains a predetermined distance from the return rail, e.g. due to a stop (which is not shown). During the latching of a clamp part the plate is pushed away upwardly (against the pretension) by the return rail 246.

The rail 246 is carried rotatably about a shaft 257 and is upwardly pretensioned by means of an elastic means 258 (e.g. a spring) in order to tension the belt 200. The belt is usually not deflected into the recess 252. Instead, the recess is bridged by the belt. A deflection to the recess occurs under pressure of plate 254 however, when the latter is pushed upwardly, as has already been described. The deflection leads to the effect as has already been described in connection with FIG. 11.

Of course, both return rails (one each per machine side) need to be provided with an apparatus in order to bring the elements of the snap-in connection into engagement with each other. In cases where the apparatus comprises a recess and plate according to FIG. 13, the two apparatuses must snap in the elements simultaneously.

FIG. 14 shows lateral parts of a flat bar 222 which is guided accordingly between two belts 200A, 200B at opposite sides of the card (not shown in FIG. 14, cf. FIG. 1). The central part of the flat bar has a breakthrough. The flat bar 222 is shown, as seen from above, on its “return path”, i.e. the flat clothing C is moving upwardly for cleaning so that the profiles 31 (FIG. 3) are not shown. The sliding blocks 228 of the end heads are shown, however. Each of the sliding blocks is fastened in a beam pair 205A, 205B to its belt accordingly. The pairs of beams which are designated with 204, 206 are situated on belt 200A adjacent to beam pair 205A are not provided with flat bars. The flat bar 222 can be the first flat for example which is placed on the belt during the mounting or subsequent maintenance.

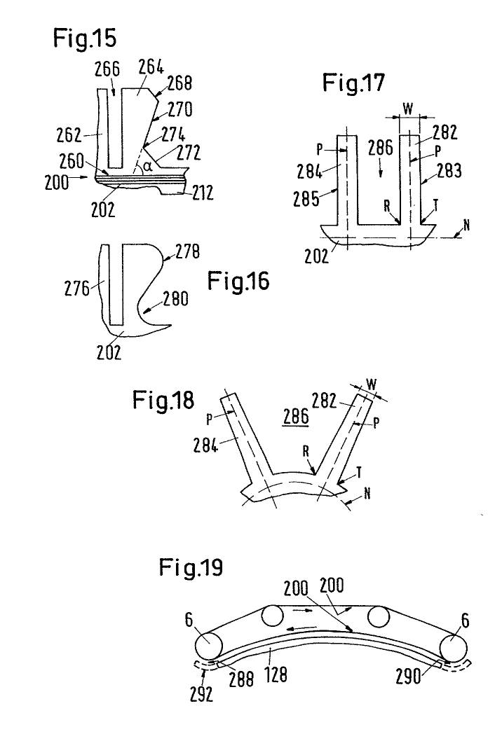

In FIG. 15, the belt is indicated again with reference numeral 200 and comprises a body part 200 with teeth 212. The body part 200 usually comprises supporting elements which extend in the longitudinal direction and are indicated only schematically with reference numerals 260. A pair of beams 262, 264 is shown in a side view. Only beam 264 is shown in its entirety. The beams 262, 264 of the pair are separated by a slot 266 which extends from the outer (free) end of the beams up to the body part 202 of the belt. The side of beam 264 which is opposite of beam 262 comprises a guide surface 268 at the outer end of the beam, an inclined holding surface 270 which is similar to surface 216 in FIG. 4, and an inclined base part 272. The inclined base part 272 is connected to the inclined holding surface 270 via a link 274. When the flat is latched onto the belt, the beam 264 bends around the link 274 instead of around a root as in the case of the beams 208, 210 (FIG. 4). Moreover, the holding surface 270 forms with the belt length in a straight position as shown in FIG. 15 an angle α (in the range of 60 to 80 degrees).

The embodiment shown in FIG. 15 shows a sharp pointed edge where two surfaces meet. This is not the actually desired shape for reasons that have already been explained. Such edges are preferably rounded off, especially when there is a likelihood that the beam is cut through at the clamping or fixed elements. A rounding off of beam surfaces can lead to a shape as indicated with reference numeral 276 in FIG. 16 where the holding surface 278 is rounded off. It will be relatively difficult to achieve a favorable cooperation between the sliding block and the beam in the last mentioned embodiment, partly for reasons that it is relatively difficult to adjust the surfaces on the sliding blocks according to the rounded-off beams. The holding surface of each beam preferably extends up to the root 280 of the beam (where it borders the body part 202 of belt 200) for reasons which will be explained below in closer detail by reference to FIGS. 17 and 18.

FIG. 17 shows a pair of beams 282, 284, with each beam having a simple rectangular profile. The beams are separated by a slot 286. Every beam 282, 284 is integrated with the body part 202 of the belt or fixedly attached to the same. The pair of beams is received by a sliding block, clamping or fastening means, similar to those as already described above, but with lateral surfaces which are adjusted to receiving the beam surfaces 283, 285. The direction of movement of the flat bars is shown in FIG. 19 with arrows. This direction has been assumed merely for purposes of graphical illustration and description. The flat bars can nevertheless move in the opposite direction. During the movement of the flat bars along the flexible bend 120 (cf. FIG. 2) or on the opposite side when the belt returns, there are no problems concerning the holding of the flat bars relative to the belt.

There should also not be any problems when the belt 200 is bent, as is shown in FIG. 18, and tends to spread apart the beams 282, 284, i.e. extending the slot 286 over its outer end. Such a spreading is shown in FIG. 18. This is actually not possible because the pair of beams is properly fastened in its sliding block and because the beams continuously rest on the lateral surfaces of the sliding blocks. The “striving” towards a spreading of the beams produces lateral forces on the walls of the sliding block however and the thus resulting friction may be sufficient to hold the flat bar for such a time until the belt is bent in the respective sense.

Problems arise in the zone of the transition zones 288, 290 (FIG. 19) where the belt bends from a curved shape (as defined by the flexible bend 128) to another one (defined by the deflection rollers 6, cf. FIG. 1), so that the frictional forces cannot arise on the flat bar. At the same time gravity tends to pull the flat away from the belt. In order to overcome the problems in zone 288 one could use a short extension piece 292 (shown with the broken line). This would create a continuous guidance of each flat when the same leaves the flexible bend 128 until the belt is bent according to the curvature of the deflection rollers 6, so that the belt is held again by the frictional forces which are produced by a respective pair of beams 282, 284. A similar extension piece can be provided in the zone 290 insofar as the frictional forces which are produced by a pair of beams are reduced before the flat bar rests on the flexible bend 128.

A simple beam (as shown in FIGS. 17 and 18) is suitable for the purpose of describing the holding effect in closer detail. It is assumed that each beam comprises a central longitudinal plane P (plane of symmetry) and that the body part 202 of the belt comprises a neutral plane N, i.e. a plane in which a belt fabric is principally not distorted when the belt is bent about an axis rectangularly to its length, but parallel to its width. In the form as shown in FIG. 17 (belt 202 is stretched in a straight fashion) the plane P of each beam is disposed at a right angle to the neutral plane N of the belt. In the state according to FIG. 18, the axis of the belt curvature is not shown, but it is disposed on the side of the belt averted from the beams 282, 284. That is why the belt fabric 200 is extended above the neutral plane N in FIG. 18 (relative to FIG. 17) and compressed below the neutral plane.

That is why the belt fabric which lies in the plane R-T in FIG. 17 (at the “root” of beam 282 where the same is adjacent to the belt body) is stretched in a bend R-T in FIG. 18 with a degree of bending which arises with the position of the bending axis (not shown). When the belt moves about the deflection roller 6, the rotational shaft of the deflection roller constitutes the bending axis. For the purpose of an explanation, it is assumed that the pair of beams 282, 284 does not carry any flat at the time of movement about the deflection roller 6, so that the beams of the pair are free to diverge as shown in FIG. 18.

The plane of symmetry P of the beam 282 will intersect the bending axis. Outside (radially outwardly) of the bend R-T there are practically no forces in the material of the belt fabric 200 which would cause an extension of the belt, so that the width W of the outer beam end remains as good as unchanged in comparison with FIG. 17. That is why each beam 282, 284 principally extends radially from the belt 200. Accordingly it is not necessary that the beams are made integrally with the body part 202 of the belt. The beams can be designed separately and be fastened thereafter to the belt in an appropriate manner. Usually, the body part of the belt is arranged integrally with the beam (and teeth 212).

In practice (during spinning operation), the problems of the following kind can occur:

1. During the mounting (also in the spinning room, e.g. after changing a set of flats) the belt is not yet tensioned after attaching the first flat bars. The connections between clamp and beam of the first bars are therefore relatively loose. Said first bars can therefore fall away into the deflection zone before the other bars have been attached to the belt. Even if this occurs only very rarely and does not represent any “damage”, the mounting work is still considerably disturbed. In view of this risk the mounting must be performed generally with rather much care (carefully) which cannot be ensured in every plant.

2. The general problem of dirt accumulation in the spinning mill also plays a role in connection with the snap-in connection. Dirt accumulations can build up in the snap-in connection (between the belt and the flat head) which tend to loosen the snap-in connection or even to “burst” the same. This tendency is supported in certain zones of the path of movement by the aforementioned loosening of the connection (due to the bending of the belt). The effect may, under certain circumstances, have such consequences that the flat head “jumps out” of the snap-in connection. Even if this happens only once per year in a single carding machine, the risk is still unacceptable for a spinning mill.

3. The problem of the tilting moment acting on the flat head has already been mentioned within the scope of the description above. This problem is increased by certain auxiliary devices in the carding machine, e.g. by the flat cleaning means (e.g. according to DE-Gbm-94 14196) or by a grinding device for the flat clothing (e.g. according to EP-A-1019218 or WO 00/13850). Such devices are usually provided in the return area. The snap-in connection should act rather rigidly in this zone. As has already been shown in the preceding paragraph, the operating conditions in the spinning mill can have a negative effect over time. The tilting moment which is produced by the concentration of forces in the zone of an auxiliary device can lead to the consequence that a flat bar will be released.

4. The material of a flexible belt is naturally susceptible to wear and tear in comparison with metallic fastening elements, as has already been mentioned in connection with FIG. 5. If the belt is not treated carefully or exchanged in due time, the holding performance of individual snap-in connections can be impaired. This risk can prove to be unacceptable, especially in combination with the aforementioned effects.

It is the object of the invention to remedy this situation. The snap-in connection is to be supplemented principally by a locking element. Embodiments are explained below by reference to FIGS. 20 through 29. It is started out in this respect on the preceding description of FIGS. 5 to 8, so that only the respective amendment by a locking element needs to be newly treated. According to the concept shown in these examples, the locking element is chosen in such a way that it prevents the mutual approach of the beams 208, 210 which is required for a loosening of the snap-in connection.

In the example according to FIG. 20, every sliding block/clamp part 228 is associated with a respective locking element in the form of a so-called clip 300 which is in engagement with the beam 208, 210 by a separate snap-in connection. The clip 300 is made of one piece and comprises a “plate” 302 which sits flush on the face surfaces 304 of beams 208, 210, a first leg 306 which extends into the slot 308 between the beam 208, 210 and stands in contact with the side surfaces of the beam 208, and a second leg 310 which also extends into the slot 308 and thereby remains in contact with the side surfaces of beam 210. Every leg is provided with a cam 312 which extends parallel to the longitudinal direction of the beams 208, 210 and snaps into a respective groove (not especially indicated) in the respective beam 208 or 210.

The legs 306, 310 are elastically deformable with respect to plate 302, so that they can be compressed when the clip needs to be snapped in. The distance between the legs 306, 310 can increase slightly with increasing distance from the plate in order to ensure that the clip does not loosen during operation. The distance between the legs 306, 310 in the vicinity of the plate is preferably equal to the nominal distance A (FIG. 5). Since the legs cannot be bent easily close to plate 302 but instead transmit the bending forces directly to the plate, the distance between beams 208, 210 cannot be reduced below the nominal distance A as long as the clip 300 remains snapped in. The snap-in connection between the flat bar and the belt body 202 is thus locked. The clip needs to be removed in order to allow the release of the flat bar from the belt.

The removal of the clip may require the destruction of the clip, so that the removed clip needs to be replaced in order to lock a snap-in connection again between the flat bar and the belt at the same place. The clip 300 can practically cover the slot between the beam 208, 210. It is also possible to leave open a short section of the slot, so that a tool can be introduced into the slot in order to remove the snap-in connection between the clip and the beam.

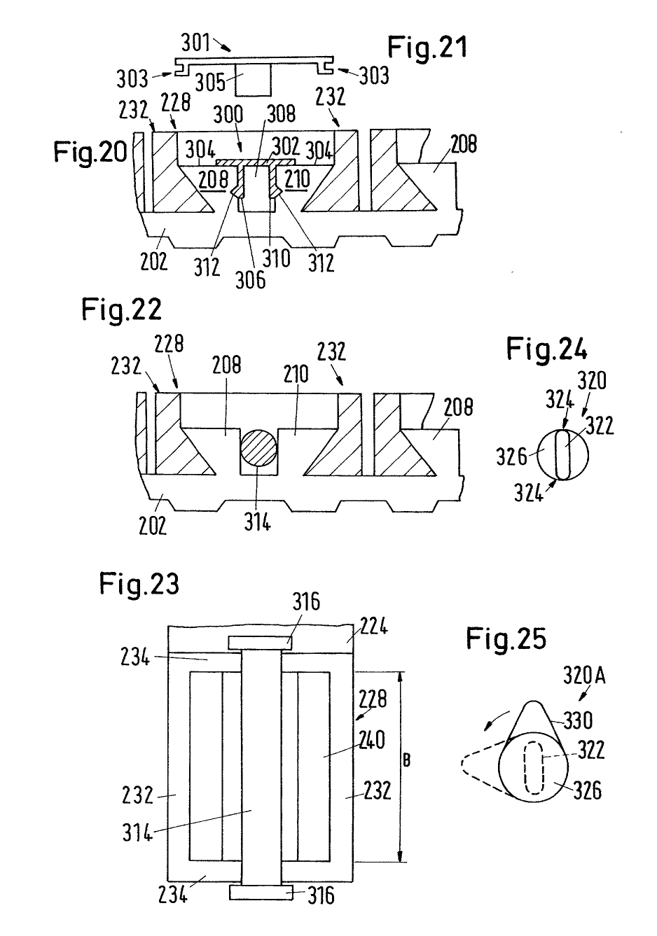

FIG. 21 schematically shows an alternative to clip 300 in the form of a cover 301 for the sliding block/clamp part 228. This cover 301 is provided with elastically deformable fastening claws 303 which can latch into openings (not shown) in part 228 between the sliding surface 232 and the beam 208, 210. The surface of the cover 301 facing the beam is provided with a bar 305 which takes up a position between beams 208, 210, practically fills the slot in the zone of the free ends of the beam and thus latches the snap-in connection. The cover 301 also protects the snap-in connection against fiber fly and dust from the ambient environment of the spinning mill. The bar could naturally also be provided with cams (not shown) similar to cams 312 and thus form a snap-in connection with the beams directly, which connection can replace or supplement the aforementioned claws. When the cross-beams 234 (FIG. 7) have a slightly lower height with respect to the rails 232, the cover can be provided with claws which cooperate with the fastening elements on the outside surfaces of the cross-beams in order to rigidly (but still detachably) attach the cover to the sliding block/clamp part.

In the variant according to FIGS. 22 and 23, the locking element is in the form of a bolt 314 which extends between the beams 208, 210 and through respective holes (not shown especially) in the cross-beams 234. Suitable securing elements 316 are provided outside of the sliding block/clamp part 228 which tightly hold the bolt 314 in its locking position. The locking function is substantially the same as that of the clip 300, with the bolt 314 being introduced between the beam 208, 210 once the snap-in connection between the flat bar and the belt has been produced. The securing elements 316 are then attached. These elements can be arranged in such a way that they need to be destroyed in order in order to allow the removal of the belt (the unlatching).

FIG. 24 shows a variant of the arrangement according to FIG. 22, according to which it is not necessary or possible to remove the locking element for unlatching because it is rigidly in engagement with the sliding block/clamp part. In this case the locking element 320 comprises a part 322 which, like the bolt 314 (FIG. 23), extends between the beam 208, 210 (not shown in FIG. 24), with the part 322 not being formed circular in its cross section but as a flat bar with rounded side surfaces 324. The bar 322 is shaped of one part with end parts 326 (only one end part 326 is visible in FIG. 24) which are received rotatably in the cross-beams 234 (cf. FIG. 23). The bar 322 is thus rotatable with the end parts 326 by an angle of approx. 90° between an unlocking position (shown in FIG. 24) and a locking position (not shown). In the locking position the side surfaces 324 each come into contact with a beam 208 or 210 and thus fulfill the locking function which has already been explained in connection with FIG. 20.

FIG. 25 shows a further variant of the principle according to FIG. 24. The locking element 320A also comprises in this case a bar-shaped part 322 and end parts 326 (only one end part is visible). One end part 326 is provided outside of the sliding block/clamp part 228 with a nose 330 which can be in contact with a radial cam during the movement of the flat bar along its path of movement. As a result of the contact of the nose 330 with the radial cam, the nose is moved from the stand-by position (shown in the unbroken line) to the operating position (shown in the broken line), which moves the part 322 to the locking position and holds it there until an opening in the radial cam allows the return swivel of the nose to its starting position.

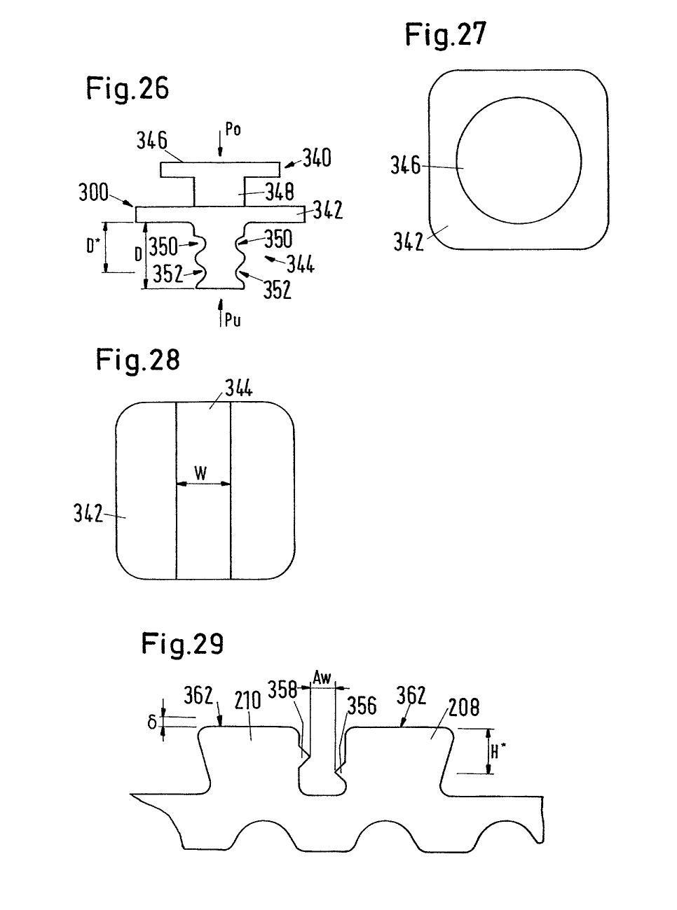

The locking element 300 according to the FIGS. 26 to 28 is preferably made of one piece, i.e. it is cast of plastic for example. The element comprises

a “mushroom-shaped” handle 340;

a rectangular flange 342, and

a bar-shaped locking bar 344.

The outside dimension of the flange 342 is smaller than the distance Mx (FIG. 7), so that the element 300 can be introduced easily between the rails 230. The length of the locking bar 344 is equal to the diameter of the outside dimension of the flange 340. The width W (FIG. 28) of the locking bar 344 is slightly smaller than the width A (FIG. 5) of slot 308 (FIG. 20) between adjacent beams 208, 210. When therefore the locking bar 344 is aligned in the longitudinal direction of the slot 308, the locking bar can be introduced between the beams 208, 210 of a pair of beams and thus prevent that said beams approach one another until the locking bar is removed again. The depth D of the locking bar 344 is preferably slightly smaller than the height H (FIG. 5) of the beams 208, 210. The handle 340 consists of a button-like head section 346 and a handle 348. A tool can be introduced between the head section 346 and the flange 342 in order to facilitate the removal of the locking element 300 from a sliding block/clamp part 228 (FIG. 7). The length of the handle 348 is chosen in such a way that the head section 346 does not project from the sliding block. The sliding block is preferably provided with a sliding layer, e.g. according to DE 19834893.

For the sake of simplicity, the element 300 is described further in the illustrated position (with the handle 340 at the top). From the preceding description it will be clear, however, that during operation the element 300 needs to work with the handle below.

Every side surface of the locking bar 344 is preferably provided with an upper groove 350 and a lower groove 352. In a preferred embodiment (FIG. 29) the mutually opposite side surfaces of the beams 208, 210 are formed with bulges which can each engage in a groove 350 or 352 depending on the locking state. The beam 208 comprises a lower bulge 356 for cooperating with a groove 352. The beam 210 comprises an upper bulge 358 for cooperation with the other groove 350. The distance Aw (FIG. 29) between the bulges 356, 358 is smaller than the width W of the locking bar, so that during the latching of the bulges a snap-in connection between the locking element 300 and the pair of beams 208, 210 is produced and the jumping out of the bulges can be avoided. It will be clear that the locking bar 344 can be provided with bulges instead of grooves and the beams 208, 210 with grooves instead of bulges.

The distance D* (FIG. 26) between the lower grooves 352 and the lower side of the flange 342 is larger than the distance H* (FIG. 29) between the lower bulge 356 and the face surfaces 362 of the beams. Accordingly, in the locked state a narrow gap δ will also remain between the flange 342 (not shown in FIG. 29) and the face surfaces 362, so that the lock will securely latch and will not stand up on the surface 362.

Because the snap-in connection can now be locked, it is no longer necessary to produce the holding forces merely on the basis of the elasticity or geometry of the beams. The holding forces which arise from the snap-in connection per se can thus be reduced (as compared with the arrangements according to EP-A-627507 or EP-A-753610), which further simplifies the attachment or removal of the flat bars. On the other hand, it is not necessary to provide securing rails at any place along the path of movement of the flat rods for the case that the snap-in connection itself does not hold.

1. A drive belt for the flat bars (222) of a revolving flat card, with the belt (200) being provided with connecting elements (208, 210) which are formed integrally with a flexible belt (202) and are arranged in pairs, so that one pair of elements (204, 206, 207) in a flat bar part (226) can be received for forming a snap-in connection, with each element comprising a cross-beam (208, 210) with an inclined surface (214, 216), with the inclined surfaces (214, 216) of one pair of beams (204, 206, 207) being faced in mutually opposite longitudinal directions of the flexible belt (202), characterized by at least one locking element which can be introduced between the connecting elements of a pair in order to prevent a mutual approaching of the connecting elements of said pair and can be removed again in order to allow the mutual approaching of the elements.

2. The belt as claimed in claim 1, characterized in that a nominal distance (A) of at least 1 mm is present at the free ends between the beams (208, 210) of a pair.

3. The belt as claimed in claim 2, characterized in that in the absence of an embrace of the beams the distance will increase when the belt (202) bends and the beams (208, 210) are situated on the convex surface of the belt (202).

4. The belt as claimed in claim 3, characterized in that the distance decreases when the belt (202) bends and the beams (208, 210 are situated on the concave surface of the belt (202) when no locking element is present between the beams.

5. The drive belt for the flat bars of a revolving flat unit, provided with an oblong elastically deformable body part (202) which comprises holding elements (208, 210; 262, 264; 276, 278; 282, 284) arranged in pairs along the length of the belt, with at least two elements of the pair having the tendency to move apart or approach one another when the belt (200) is bent along the revolving path of the flat bars of a carding machine (FIG. 19), characterized by at least one locking element which can be introduced between adjacent holding elements in order to prevent the mutual approach of said elements.

6. The drive belt as claimed in claim 5, characterized in that the belt is connected with a flat which comprises a connecting part (41), with said connecting part substantially preventing the divergence of elements (208, 210; 262, 264; 276, 278; 282, 284).

7. A revolving flat unit, characterized by a pair of drive belts, of which each belt (200) is formed according to claim 6.

8. The unit as claimed in claim 7, characterized in that each locking element is or can be attached to a connecting part.

9. The unit as claimed in claim 7, characterized in that each locking element can be attached to a belt.

10. The unit as claimed in one of the preceding claims 7 to 9, characterized in that each snap-in connection develops a carrying force which is smaller than half the weight of the flat bar (222).

11. The unit as claimed in claim 10, characterized in that the weight of the flat bar (222) is between 15 N and 40 N.

12. A snap-in connection between a flat rod and a drive belt, characterized by a locking element which prevents any inadvertent loosening of the snap-in connection.

13. The connection as claimed in claim 12, characterized in that the locking element can be held in an operating position by a snap-in connection with the belt or the flat bar.

14. The connection as claimed in claim 12, characterized in that the locking element can be fastened to the flat bar.

15. The connection as claimed in claim 14, characterized in that the locking element is fastened movably on the flat bar, so that the locking element can be moved between an operating and a stand-by position.

16. A locking element for locking a snap-in connection between a drive belt and a sliding section of a flat bar, with the belt being provided with elastic connecting elements (208, 210) which are arranged in pairs so that a distance (308) is left between the elements of a pair, characterized by a head section (340), preferably with a handle, and a locking bar (344) which can be introduced between the connecting elements (208, 210) in order to substantially bridge the distance (308).

17. The locking element as claimed in claim 16, characterized by a flange (342) between the head section and the locking bar.

18. The locking element as claimed in claim 16 or 17, characterized in that the element is made from one piece.

19. The locking element as claimed in one of the claims 16 to 18, characterized in that the locking bar (344) is provided with grooves (350) and/or bulges which can also form a snap-in connection with the connecting elements (208, 210).
